(19) United States
(12) Patent Application Publication
(10) Pub. No.: US 2004/0260711 A1
(43) Pub. Date: Dec. 23, 2004

(54) Profiling data in a data store

(75) Inventors: Amanda Elizabeth Chessell, Alton (GB); Vernon Maurice Green, Newbury (GB); Graham Alan Eveleigh, Bitterne (GB)

Correspondence Address: IBM Corporation, IP Law Department, 11400 Burnet Road, Austin, TX, 78758, US

(73) Assignee: International Business Machines Corporation, Armonk, NY

(21) Appl. No.: 10/798,920

(22) Filed: Mar. 11, 2004

(30) Foreign Application Priority Data
Jun. 21, 2003 (GB) 0314591.9

(51) Int. Cl. G06F 17/00

(52) U.S. Cl. 707/100

(57) ABSTRACT

A method for, in a data store including a first set of one or more data items, accessing a selected set including a second set of one or more data items in accordance with a selection rule, the method including the steps of: creating a profile of the data store, the profile including a profile rule defining a profile set, wherein the profile set includes a third set of one or more data items in accordance with the profile rule; if there is a non-empty intersection of the selected set and the profile set, extracting a fourth set of one or more data items from the data store in accordance with the selection rule; and if there is not a non-empty intersection of the selected set and the profile set, providing an indication that the data store does not include data items in the selected set.

### FIELD OF THE INVENTION

This invention relates to the generation of a profile of data in a data store and particularly to the use of a profile of data in a data store to identify situations where a selected set of data items does not exist in the data store.

### BACKGROUND OF THE INVENTION

Software applications in a computer system use a data store to record items of data. A data store usually consists of a physical storage device and data storage software. The physical storage device can be any storage device capable of storing data, such as a disk drive. The data storage software provides software applications with functions for managing the storage and retrieval of data items in the physical storage device. An example of data storage software is an input/output (I/O) software library within an operating system. Another example of data storage software is a database system such as a relational database management system (RDBMS).

An application can extract one or more data items from a data store by sending a request to the data store identifying the data items to be retrieved. For example, where a data store is implemented using a database system, an application can request to extract data items from the data store using a database query. A database query is a command to the database system to extract data from the data store which satisfies one or more criteria. The criteria are specified as a logical rule, and data items in the data store must satisfy this rule if they are to be retrieved by the database system and returned to the requesting application.

By way of example, the table below depicts a data store including five data items. Access to the data items is managed by a database system. Each data item includes a unique number (in the “IDENTIFIER” column) and a single piece of numerical data (in the “VALUE” column). The data items in the data store can be accessed by an application by sending a database query to the database system. For example, the application sends the query “SELECT WHERE VALUE>55” to the database system. The database system then applies the rule “VALUE>55” to each data item in the data store. Those data items which satisfy the rule are retrieved by the database system and returned to the application. Thus, data items with identifiers ‘2’ and ‘4’ are returned to the application because the corresponding “VALUE” entries for these data items satisfy the rule of the database query.

| IDENTIFIER | VALUE |
|---|---|
| 1 | 52 |
| 2 | 64 |
| 3 | 34 |
| 4 | 57 |
| 5 | 45 |

Thus in order to identify data items in a data store which satisfy a rule in a database query a database system must apply the rule to each and every data item in the data store. This can take a long time where a data store contains a large number of data items, or where the rule is complex. Furthermore, if there are no data items in the data store which satisfy the rule of the database query, the time spent by the database system applying the rule to each and every data item is wasted because no data items will satisfy the rule. Thus when an application requests to extract data from a data store which meets a defined rule it would be desirable to identify situations where there can be no data items in the data store which meet the rule before applying the rule to each and every data item.

### SUMMARY OF THE INVENTION

The present invention accordingly provides, in a first aspect, a method for, in a data store comprising a first set of one or more data items, accessing a selected set comprising a second set of one or more data items in accordance with a selection rule, the method comprising the steps of: creating a profile of the data store, the profile comprising a profile rule defining a profile set, wherein the profile set comprises a third set of one or more data items in accordance with the profile rule; responsive to a determination that there is a non-empty intersection of the selected set and the profile set, extracting a fourth set of one or more data items from the data store in accordance with the selection rule; and responsive to a determination that there is not a non-empty intersection of the selected set and the profile set, providing an indication that the data store does not include data items in the selected set. Thus the profile rule describes all data items in the data store, and the profile set is defined comprising all possible data items which satisfy the profile rule. Similarly the selected set is defined comprising all possible data items which satisfy the selection rule. If there is no intersection of the profile set and the selected set then there can be no data items in the data store which satisfy the selection rule. Conversely, if there is a non-empty intersection of the profile set and the selected set then there may be data items in the data store which satisfy the selection rule. Thus the present invention provides a way to identify situations where there can be no data items in the data store which meet the selection rule.

Preferably the data store includes a relational database.

Preferable the data store includes a disk storage device.

Preferably the profile is created when the data store is otherwise idle.

The present invention accordingly provides, in a second aspect, a computer program product directly loadable into the internal memory of a digital computer, comprising software code portions for performing, when said product is run on a computer, the method of, in a data store comprising a first set of one or more data items, accessing a selected set comprising a second set of one or more data items in accordance with a selection rule, the method comprising the steps of: creating a profile of the data store, the profile comprising a profile rule defining a profile set, wherein the profile set comprises a third set of one or more data items in accordance with the profile rule; responsive to a determination that there is a non-empty intersection of the selected set and the profile set, extracting a fourth set of one or more data items from the data store in accordance with the selection rule; and responsive to a determination that there is not a non-empty intersection of the selected set and the profile set, providing an indication that the data store does not include data items in the selected set.

The present invention accordingly provides, in a third aspect, a computer program product stored on a computer usable medium, comprising: computer readable program means for storing data, the means for storing data being operable to store a first set of one or more data items; computer readable program means for extracting a selected set from the data store, wherein the selected set comprises a second set of one or more data items in accordance with a selection rule; computer readable program means for generating a profile of the first set of one or more data items, the profile comprising a profile rule defining a profile set, wherein the profile set comprises a third set of one or more data items in accordance with the profile rule; and computer readable program means for determining if there is a non-empty intersection of the selected set and the profiler set.

The present invention accordingly provides, in a fourth aspect, an apparatus having a data store operable to store a first set of one or more data items, the apparatus further comprising: a selector for extracting a selected set from the data store, wherein the selected set comprises a second set of one or more data items in accordance with a selection rule; a profiler for generating a profile of the data store, the profile comprising a profile rule defining a profile set, wherein the profile set comprises a third set of one or more data items in accordance with the profile rule; and a selection checker for determining if there is a non-empty intersection of the selected set and the profiler set.

### BRIEF DESCRIPTION OF THE DRAWINGS

A preferred embodiment of the present invention will now be described by way of example only, with reference to the accompanying drawings, in which:

FIG. 1 is a schematic diagram illustrating a configuration of a computer system in a preferred embodiment of the present invention;

FIG. 2 is a flowchart illustrating an exemplary method for the profiler 100 of FIG. 1 in the preferred embodiment of the present invention;

FIG. 3a is a flowchart illustrating an exemplary method to generate the profile rule of FIG. 1 for numeric data items in the data store of FIG. 1 in the preferred embodiment of the present invention;

FIG. 3b is a flowchart illustrating an exemplary method to generate the profile rule of FIG. 1 for string data items in the data store of FIG. 1 in the preferred embodiment of the present invention;

FIG. 3c is a flowchart illustrating an exemplary method to generate the profile rule of FIG. 1 for date data items in the data store of FIG. 1 in the preferred embodiment of the present invention;

FIG. 4 is a diagram illustrating an example of a database table stored in the data store of FIG. 1 in the preferred embodiment of the present invention.

### DETAILED DESCRIPTION OF THE PREFERRED EMBODIMENT

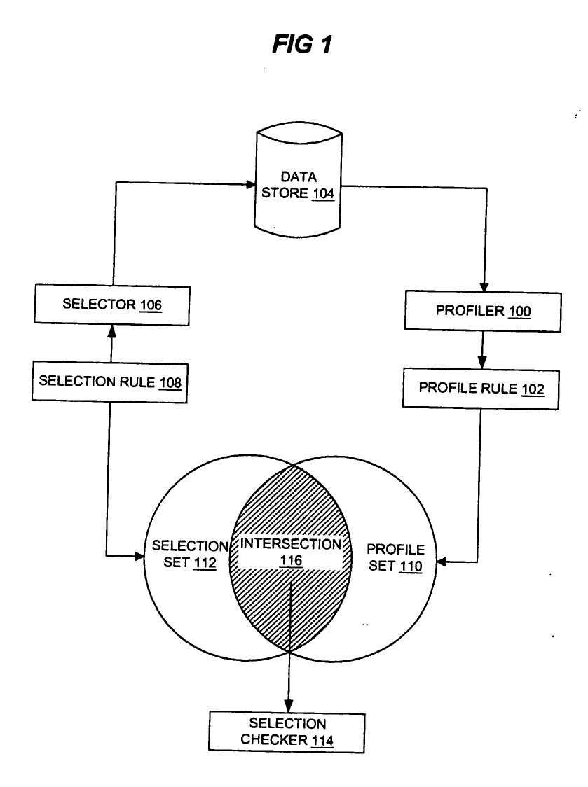

FIG. 1 is a schematic diagram illustrating a configuration of a computer system in a preferred embodiment of the present invention. The computer system (not shown) includes a data store 104. The data store 104 is used by software applications for the storage and retrieval of data items. The data items stored in the data store may include data of any type such as numerical data, character based data, date information, graphical data, sound data or video data. In the preferred embodiment the data store 104 includes a hard disk drive and a database system such as a relational database management system. The database system stores data items as records in one or more database tables. Each database table consists of one or more columns in which data of a particular data type is stored as is commonly known in the art. Alternatively, the data store includes any physical storage device, such as random access memory, tape storage, or a redundant array of inexpensive disks (RAID) and any data storage software such as an input/output (I/O) software library within an operating system, a hierarchical database or an object oriented database.

FIG. 1 also includes a profiler 100 which generates a profile rule 102 for the data store 104. In the preferred embodiment the profiler 100 is a software module which is functionally connected to the data store 104. Alternatively, the profiler 100 forms a part of the data storage software in the data store 104, such as a software module in a database system. In a further alternative, the profiler 100 may comprise apparatus operable to generate the profile rule 102 for the data store 104. Such an apparatus may be a dedicated device or a general purpose device. The profile rule 102 is a logical rule which describes the data items in the data store 104. For example, a profile rule 102 for a data store 104 containing the numerical data items ‘5’, ‘7’, and ‘9’ is defined below:

(x [symbol] 5) [symbol] (x [symbol] 9)

Here x is an identifier corresponding to “all data items”, and [symbol] is a mathematical operator corresponding to the logical AND operation. Thus the above profile rule 102 can be described in English as “all data items are greater than or equal to five and all data items are less than or equal to nine”. The profile rule 102 is said to describe the data in the data store 104. More than one profile rule 102 can be used to describe different data in the data store 104. For example, if the data store 104 is implemented using a database table in a database system, a profile rule 102 may exist for each column in the database table. Additionally, a profile rule 102 can apply to more than one column in such a database table. In the preferred embodiment the profiler 100 generates the profile rule 102 for data store 104 when the data store 104 is otherwise idle.

FIG. 1 further includes a selector 106 which, in the preferred embodiment, is a software module functionally connected to the data store 104. The selector 106 processes requests by software applications to extract data items from the data store 104 according to a selection rule 108. Alternatively, the selector 106 forms a part of the data storage software in the data store 104, such as a software module in a database system. In a further alternative, the selector 106 may comprise apparatus operable to process requests by software applications to extract data items from the data store 104. Such an apparatus may be a dedicated device or a general purpose device. The selection rule 108 is a logical rule which specifies the data items in the data store 104 which are to be extracted from the data store 104 for a software application. For example, an application which requests to extract all numerical data items in the data store 104 which have a value greater than eight will use the selection rule 108:

x>8

Again x is an identifier corresponding to “all data items”. Thus the above selection rule 108 can be described in English as “all data items that are greater than eight”. The profile rule 102 and the selection rule 108 mathematically define a profile set 110 and a selected set 112 respectively. The profile set 110 is a set of all possible data items which satisfy the profile rule 102. Similarly, the selected set 112 is a set of all possible data items which satisfy the selection rule 108. Profile set 110 and selected set 112 can be expressed in formal notation using the profile rule 102 and the selection rule 108. For example, a profile rule 102 and corresponding profile set 110 is defined using formal notation below:

Profile Rule 102=(x [symbol] 5) [symbol] (x [symbol] 9)

Profile Set 110={xεZ:(x [symbol] 5) [symbol] (x [symbol] 9)}

In the profile set 110 above the following notation is used:

“Z” is a set of integers containing all whole numbers, positive and negative, and zero. For example, Z contains numbers such as ‘6’, ‘−3’, ‘0’ and so on;

“{ . . . }” is formal notation representing “the set of”. A definition of a set is included within the curly brackets in place of “ . . ”;

“ε” is formal notation representing “belonging to”; and

“:” is formal notation representing “where x satisfies”.

Thus the profile set 110 above can be described in English as “the set of all data items belonging to the set of integers where all data items are greater than or equal to five and all data items are less than or equal to nine”. Similarly an example of a selection rule 108 and corresponding selected set 112 is defined using formal notation below:

Selection Rule 108=x>8

Selected Set 112={xεZ:x>8}

The selected set 112 above can be described in English as “the set of all data items belonging to the set of integers where all data items are greater than eight”.

FIG. 1 further includes a selection checker 114 which determines if there is a non-empty intersection 116 of the profile set 110 and the selected set 112. In the preferred embodiment the selection checker 114 is a software module which has access to the profile rule 102 and the selection rule 108. Alternatively the selection checker 114 may comprise apparatus operable to determine if there is a non-empty intersection 116 of the profile set 110 and the selected set 112. Such an apparatus may be a dedicated device or a general purpose device. The intersection 116 of the profile set 110 and the selected set 112 is defined as the set of data items which belong to both the profile set 110 and the selected set 112, and is shaded in FIG. 1. A non-empty intersection 116 indicates that there may be data items in the data store 104 which satisfy the selection rules 108. Conversely, if the selection checker 114 determines that the intersection of the profile set 110 and the selected set 112 is the empty set (i.e. “{ }”), then there are no data items which belong to both the profile set 110 and the selected set 112. This would indicate that there are no data items in the data store 104 which satisfy the selection rules 108.

As an example, taking the profile set 110 and selected set 112 defined above, the selection checker 114 evaluates the intersection 116 of the two sets as expressed using formal notation below:

Intersection 116={xεZ:(x [symbol] 5) [symbol] (x [symbol] 9)}∩{xεZ:x>8}

The ∩ symbol represents a mathematical intersection operator. This intersection operation results in a new set, the intersection 116, representing those data items belonging to both the profile set 110 and the selected set 112. The intersection 116 can be evaluated as follows:

{xεZ:(x [symbol] 5) [symbol] (x [symbol] 9)}∩{xεZ:x>8}={xεZ:(x>8) [symbol] (x [symbol] 9)}

Thus in this example there is a non-empty intersection 116 of the profile set 110 and the selected set 112 because the intersection 116 is not the empty set. This indicates that a data store 104 including data items in accordance with the profile rule 102 “(x [symbol] 5) [symbol] (x [symbol] 9)” may contain data items which satisfy the selection rule 108 “x>8”. This determination is made by selection checker 114 and is subsequently used by selector 106 to further determine whether the selector 106 needs to search through the data store 104 in order to identify data items which satisfy the selection rule 108. If the selection checker 114 determines that the intersection 116 is the empty set, there is no need for the selector 106 to search through the data store 104 for data items which meet the selection rule 108 because no data items in the data store will meet the selection rule 108.

A determination of whether there is a non-empty intersect 116 between the profile set 110 and the selected set 112 can be achieved in software using a logical AND operation on the profile rule 102 and the selection rule 108. The logical AND operation applied to the profile rule 102 and the selection rule 108 corresponds to a logical rule defining the intersection 116. If the logical AND operation results in a rule which is impossible to satisfy, the intersect 116 between the profile set 110 and the selected set 112 is empty, because there can be no data items which satisfy an impossible rule. A way to check if such a logical AND operation is impossible to satisfy is to determine if the rule includes a contradiction. For example, if the profile rule 102 is “x>8” and the selection rule 108 is “x<5”, the result of an AND operation on the profile rule 102 and the selection rule 108 is “(x>8) AND (x<5)”. This resulting AND operation corresponds to a logical rule defining the intersection 116, and includes a contradiction because no data item can have a value greater than eight and less than five. Thus the contradiction in this rule defines an empty intersection 116.

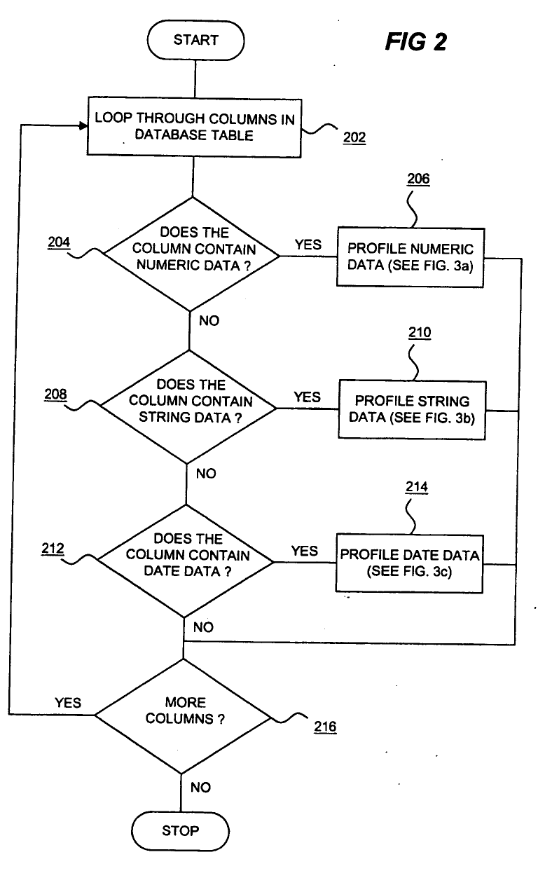

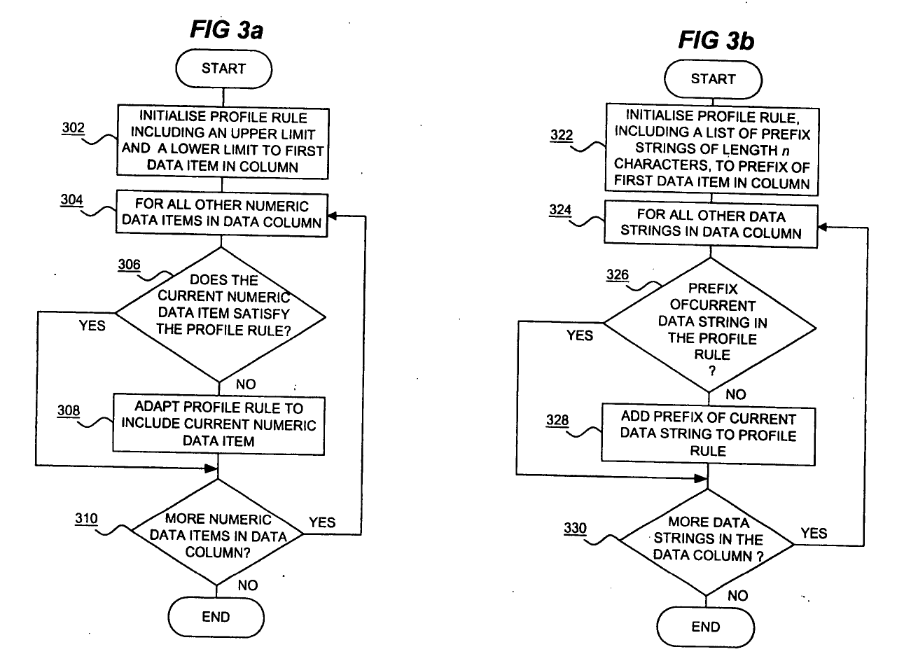

FIG. 2 is a flowchart illustrating an exemplary method for the profiler 100 of FIG. 1 in the preferred embodiment of the present invention. At step 202, the profiler 100 initiates a loop through a set of columns of data items in a database table within the data store 104. At step 204 the profiler 100 checks, for a first column, if the column contains numeric data. If step 204 determines that the column does contain numeric data, a profile rule 102 for all numeric data items in the column is created at step 206 using the method of FIG. 3a described below. If step 204 determines that the column does not contain numeric data, the profiler 100 checks if the column contains “string” data at step 208. String data comprises one or more characters appearing in a particular order. For example, “Dog”, “A” and “Banana” are strings. If step 208 determines that the column does contain string data, a profile rule 102 for all string data items in the column are created at step 210 using the method of FIG. 3b described below. If step 208 determines that the column does not contain string data, the profiler 100 checks if the column contains “date” data at step 212. Date data consists of calendar dates formatted as YYYY-MM-DD where YYYY is a four digit year indicator (such as 1999, 2000 and so on), MM is a two digit month indicator (such as 03 for March and so on) and DD is a day indicator (such as 01, 02, 03 and so on). If step 212 determines that the column does contain date data, a profile rule 102 for all date data items in the column are created at step 214 using the method of FIG. 3c described below. Subsequently at step 216 the profiler 100 checks if there are any more columns to be processed in the database table. If there are more columns to be processed, the method returns to step 202.

The structure of a profile rule 102 and an example method to create a profile rule 102 for each of numerical, string and date data in the data store 104 respectively will now be described. A data store 104 containing numerical data will be considered first. In the preferred embodiment, a profile rule 102 for a data store 104 containing numeric data includes an upper numerical limit and a lower numerical limit as defined below:

(x [symbol] LOWER LIMIT) [symbol] (x [symbol] UPPER LIMIT)

Thus the profile rule describes the data store as consisting of numerical data items which are greater than or equal to a LOWER LIMIT and less than or equal to an UPPER LIMIT. Alternatively, the profile rule 102 can include a more a complex logical rule or specify exact numerical values of data items in the data store 104. For example, the profile rule 102 can include two ranges of numerical values such as “((x [symbol] 34) [symbol] (x [symbol] 45)) OR ((x [symbol] 52) [symbol] (x [symbol] 64))”. FIG. 3a is a flowchart illustrating an exemplary method to generate the profile rule 102 of FIG. 1 for numeric data items in the data store 104 of FIG. 1 in the preferred embodiment of the present invention. At step 302 the profiler 100 initialises a profile rule 102. When the profile rule 102 is first initialised, the upper numerical limit and lower numerical limit are set to a value of a first numerical data item in the data store 104. At step 304 the profiler 100 initiates a loop through each subsequent numeric data item in the data store 104. At step 306 the profiler 100 determines if, for a current numeric data item, a value of the current numeric data item satisfies the profile rule 102. The value of the current numeric data item satisfies the profile rule 102 if it is greater than or equal to the lower limit of the profile rule 102, and if it is less than or equal to the upper limit of the profile rule 102. If the value of the current numeric data item does not satisfy the profile rule 102 then step 308 adapts the profile rule 102 to include the current numeric data item. The profile rule 102 is adapted by changing one of the lower limit or the upper limit of the profile rule 102 to include the value of the current numeric data item. Finally at step 310 the profiler 100 checks if there are any more data items to be processed in the data store 104. If there are more data items to be processed, the method returns to step 304.

A data store 104 containing string data will be considered next. In the preferred embodiment, a profile rule 102 for a data store 104 containing string data items defines a list of prefix strings of a certain length. Every data item in the data store 104 is prefixed by one of the prefix strings in the profile rule 102. For example, a profile rule 102 for a data store 104 containing the string data items “ATOK”, “JWIL”, and “ATEJ” is defined below:

STARTSWITH(x, “AT”) [symbol] STARTSWITH(x, “JW”)

Here, [symbol] is a mathematical operator corresponding to the logical OR operation, and STARTSWITH is a function which is defined using formal notation below:

STARTSWITH: STRING×STRING→BOOLEAN (s, t) [symbol] σ

where

σ=true if the prefix of s is t

σ=false if the prefix of s is not t.

In the definition of the STARTSWITH function the following notation is used:

“STARTSWITH:” defines the name of the function;

“STRING×STRING→BOOLEAN” declares that the function accepts two arguments which are strings, and the function evaluates to a boolean value, i.e. true of false;

“(s, t) [symbol] σ” specifies that the two arguments are referred to as s and t, and that the result of the function is referred to as σ; and

“where” defines how the function is evaluated for different values of s and t.

Thus the profile rule 102 “STARTSWITH(x, “AT”) [symbol] STARTSWITH(x, “JW”)” describes the data store 104 as consisting of string data items which all have the prefix string “AT” or the prefix string “JW”. Alternatively, the profile rule 102 can include a more a complex logical rule or specify exact string values of data items in the data store 104. For example, profile rule 102 can include a logical rule involving one or more suffix strings, or other logical rules defining some commonality between data items in the data store 104. FIG. 3b is a flowchart illustrating an exemplary method to generate the profile rule 102 of FIG. 1 for string data items in the data store 104 of FIG. 1 in the preferred embodiment of the present invention. At step 322 the profiler 100 initialises a profile rule 102. When the profile rule 102 is first initialised, the profile rule 102 is initialised to include the-prefix string of the first data item in the data store 104. At step 324 the profiler 100 initiates a loop through each subsequent string data item in the data store 104. At step 326 the profiler 100 determines if, for a current string data item, a prefix string of the current string data item is included in the profile rule 102. If the prefix string of the current string data item is not included in the profile rule 102 then step 328 adds the prefix string of the current string data item to the profile rule 102. Finally at step 330 the profiler 100 checks if there are any more data items to be processed in the data store 104. If there are more data items to be processed, the method returns to step 324.

A data store 104 containing date data will be considered next. In the preferred embodiment, a profile rule 102 for a data store 104 containing date data includes an earliest date and a latest date as defined below:

[symbol]

EARLIERTHAN(x, EARLIEST DATE) [symbol] [symbol] LATERTHAN(x, LATEST DATE)

Here, the [symbol] symbol represents the logical NOT operator. Also, EARLIERTHAN and LATERTHAN are functions which are defined using formal notation below:

EARLIERTHAN: DATE×DATE→BOOLEAN (d, e) [symbol] σ

where

σ=true if d is earlier than e

σ=false if d is not earlier than e.

LATERTHAN:DATE×DATE→BOOLEAN (d, e) [symbol] σ

where

σ=true if d is later than e

σ=false if d is not later than e.

Thus the profile rule “ [symbol] EARLIERTHAN(x,EARLIEST DATE) [symbol] [symbol] LATERTHAN(x, LATEST DATE)” describes the data store as consisting of date data items which are not earlier than an EARLIEST DATE and not later than a LATEST DATE. Alternatively, the profile rule 102 can include a more a complex logical rule or specify exact date values of data items in the data store 104. For example, the profile rule 102 can include two ranges of dates such as “( [symbol] EARLIERTHAN(x, 1999-04-01) [symbol] [symbol] LATERTHAN(x, 1999-12-31)) OR ( [symbol] EARLIERTHAN(x, 2000-01-01) [symbol] [symbol] LATERTHAN(x, 2002-12-31))”. FIG. 3c is a flowchart illustrating an exemplary method to generate the profile rule 102 of FIG. 1 for date data items in the data store 104 of FIG. 1 in the preferred embodiment of the present invention. At step 342 the profiler 100 initialises a profile rule 102. When the profile rule 102 is first initialised, the earliest date and latest date are set to a value of a first date data item in the data store 104. At step 344 the profiler 100 initiates a loop through each subsequent date data item in the data store 104. At step 346 the profiler 100 determines if, for a current date data item, a value of the current date data item satisfies the profile rule 102. The value of the current date data item satisfies the profile rule 102 if it is not earlier than the earliest date of the profile rule 102, and if it is not later than the latest date of the profile rule 102. If the value of the current numeric data item does not satisfy the profile rule 102 then step 348 adapts the profile rule 102 to include the current numeric data item. The profile rule 102 is adapted by changing one of the earliest date or latest date of the profile rule 102 to include the value of the current date data item. Finally at step 350 the profiler 100 checks if there are any more data items to be processed in the data store 104. If there are more data items to be processed, the method returns to step 344.

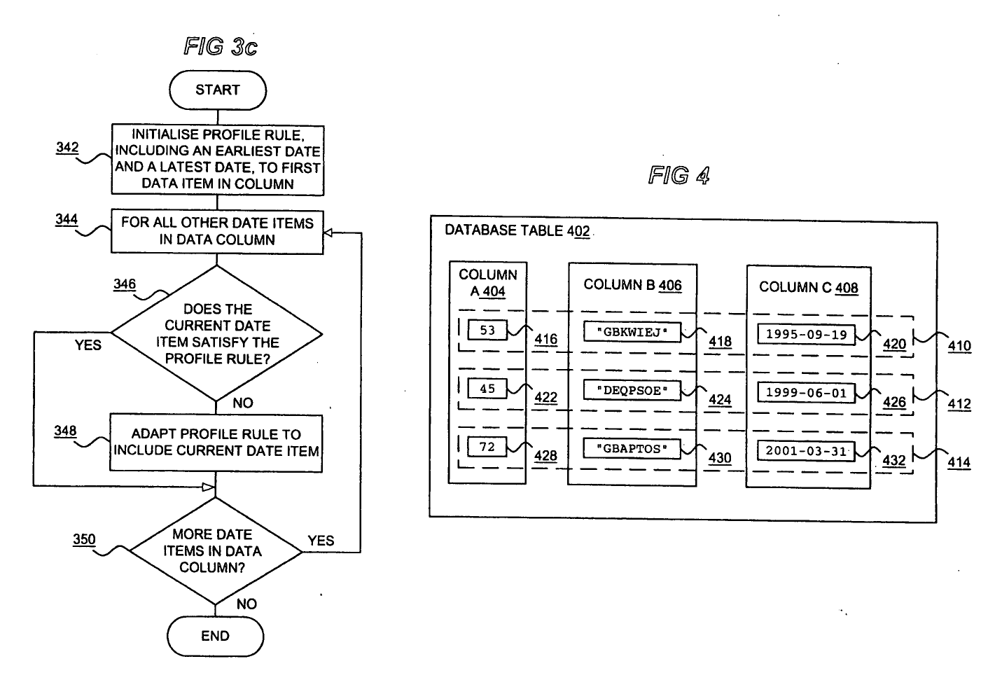

The preferred embodiment of the present invention shall now be described in use. FIG. 4 is a diagram illustrating an example of a database table stored in the data store 104 of FIG. 1 in the preferred embodiment of the present invention. The database table 402 includes the following columns: column A 404 which contains numerical data; column B 406 which contains string data; and column C 408 which contains date data. Data records 410, 412, and 414 are stored within the database table 402. Data record 410 contains a numeric data field 416 in column A 404, a string data field 418 in column B 406 and a date data field 420 in column C 408. Similarly, data records 412 and 414 contain numeric, string and date fields spread across columns A 404, B 406 and C 408 respectively. A profile rule 102 will now be created for each of the columns A 404, B 406 and C 408 in turn with reference to the methods described above and illustrated in FIGS. 2, 3a, 3b and 3c.

Turning first to FIG. 2 for the database table 402 in FIG. 4, at step 202 the profiler 100 initiates a loop through the columns A 404, B 406 and C 408 in database table 402. Starting with column A 404, at step 204 the profiler 100 determines that column A 404 contains numeric data and proceeds to step 206. At step 206 the method of FIG. 3a is used to create a profile rule 102 for all numerical data in column A 404. Turning-now to the method of FIG. 3a, at step 302 the profiler 100 initialises a profile rule 102 for column A 404 including an upper numerical limit and lower numerical limit. The upper and lower numerical limits are initially set to a value of a first numerical data item in column A 404. The first numerical data item in column A 404 is the numerical field 416 with the value ‘53’.The upper and lower numerical limits are therefore initially set to the value ‘53’.Thus, at this point the profile rule 102 for column A 404 is:

(x [symbol] 53) [symbol] (x [symbol] 53)

At step 304 the profiler 100 initiates a loop through each subsequent numerical data item in column A 404 starting with numerical field 422. At step 306 the profiler 100 determines if the value of numerical field 422 satisfies the profile rule 102 for column A 404. The profile rule 102 for column A 404 at this point is “(x [symbol] 53) [symbol] (x [symbol] 53)” and the numerical value of field 422 is ‘45’.Thus step 306 determines that the numerical value of the field 422 does not satisfy the profile rule 102 for column A 404 and proceeds to step 308. At step 308 the profile rule 102 for column A 404 is adapted to include the value of field 422 by changing the lower limit of the profile rule 102 to the value of field 422. Thus, at this point the profile rule 102 for column A 404 is:

(x [symbol] 45) [symbol] (x [symbol] 53)

Subsequently at step 310 the profiler 100 checks if there are any more numerical fields to be processed in column A 404. Step 310 determines that field 428 is yet to be processed and returns to step 304. At step 304 the profiler 100 loops to the next numerical data item in column A 404 which is numerical field 428. At step 306 the profiler 100 determines if the value of numerical field 428 satisfies the profile rule 102 for column A 404. The profile rule 102 for column A 404 at this point is “(x [symbol] 45) [symbol] (x [symbol] 53)” and the numerical value of field 428 is ‘72’. Thus step 306 determines that the numerical value of the field 428 does not satisfy the profile rule 102 for column A 404 and proceeds to step 308. At step 308 the profile rule 102 for column A 404 is adapted to include the value of field 428 by changing the upper limit of the profile rule 102 to the value of field 428. Thus, at this point the profile rule 102 for column A 404 is:

(x [symbol] 45) [symbol] (x [symbol] 72)

Subsequently at step 310 the profiler 100 checks if there are any more numerical fields to be processed in column A 404 and determines that all numerical fields have been processed. On completion of the method of FIG. 3a for column A 404 the profile rule 102 for column A 404 is “(x [symbol] 45) [symbol] (x [symbol] 72)”.

Returning now to the method of FIG. 2 on completion of step 206, step 216 determines that there are more columns of database 402 to be processed and returns to step 202 where the next column, column B 406, is processed. At step 204 the profiler 100 determines that column B 406 does not contain numerical data and proceeds to step 208. At step 208 the profiler 100 determines that column B 406 does contain string data and proceeds to step 210. At step 210 the method of FIG. 3b is used to create a profile rule 102 for all string data in column B 406. Turning now to the method of FIG. 3b, at step 322 the profiler 100 initialises a profile rule 102 for column B 406 to include the prefix string of the first data item in column B 406. The first data item in column B 406 is the string field 418 with the value “GBKWIEJ”. Using prefix strings of two characters in length, the profile rule 102 for column B 406 is therefore set to:

STARTSWITH(x, “GB”)

At step 324 the profiler 100 initiates a loop through each subsequent string data item in column B 406 starting with string field 424. At step 326 the profiler 100 determines if the value of string field 424 satisfies the profile rule 102 for column B 406. The profile rule 102 for column B 406 at this point is “STARTSWITH(x, “GB”)” and the value of string field 424 is “DEQPSOE”. Thus step 326 determines that the value of string field 424 does not satisfy the profile rule 102 for column B 406 and proceeds to step 328. At step 328 the prefix string of string field 424 is added to the profile rule 102 for column B 406. At this point the profile rule 102 for column B 406 is:

STARTSWITH(x, “GB”) [symbol] STARTSWITH(x, “DE”)

Subsequently at step 330 the profiler 100 checks if there are any more string fields to be processed in column B 406. Step 330 determines that field 430 has yet to be processed and returns to step 324. At step 324 the profiler loops to the next string data item in column B 406 which is string field 430. At step 326 the profiler 100 determines if the value of string field 430 satisfies the profile rule 102 for column B 406. The profile rule 102 for column B 406 at this point is “STARTSWITH(x, “GB”) [symbol] STARTSWITH(x, “DE”)” and the value of field 430 is “GBAPTOS”. Thus step 326 determines that the string value of field 430 does satisfy the profile rule 102 for column B 406 and proceeds to step 330. At step 330 the profiler 100 checks if there are any more string fields to be processed in column B 406 and determines that all string fields have been processed. On completion of the method of FIG. 3b for column B 406 the profile rule 102 for column B 406 is “STARTSWITH(x, “GB”) [symbol] STARTSWITH(x, “DE”)”.

Returning now to the method of FIG. 2 on completion of step 210, step 216 determines that there are more columns of database 402 to be processed and returns to step 202 where the next column, column C 408, is processed. At step 204 the profiler 100 determines that column C 408 does not contain numerical data and proceeds to step 208. At step 208 the profiler 100 determines that column C 406 does not contain string data and proceeds to step 212. At step 212 the profiler 100 determines that column C 406 does contain date data and proceeds to step 214. At step 214 the method of FIG. 3c is used to create a profile rule 102 for all date data in column C 408. Turning now to the method of FIG. 3c, at step 342 the profiler 100 initialises a profile rule 102 for column C 408 including an earliest date and a latest date. The earliest and latest dates are initially set to a value of a first date field in column C 408. The first date field in column C 408 is date field 420 with the value “1995-09-19”. Thus, at this point the profile rule 102 for column C 408 is:

[symbol]

EARLIERTHAN(x, “1995-09-19”) [symbol] [symbol] LATERTHAN(x, “1995-09-19”)

At step 344 the profiler 100 initiates a loop through each subsequent date field in column C 408 starting with date field 426. At step 346 the profiler 100 determines if the value of date field 426 satisfies the profile rule 102 for column C 408. The profile rule 102 for column C at this point is “ [symbol] EARLIERTHAN(x, “1995-09-19”) [symbol] [symbol] LATERTHAN(x, “1995-09-19”)” and the value of field 426 is “1999-06-01”. Thus step 346 determines that the value of the field 426 does not satisfy the profile rule 102 of column C 408 and proceeds to step 348. At step 348 the profile rule 102 for column C 408 is adapted to include the value of field 426 by changing the latest date of the profile 102 to the value of field 426. Thus at this point the profile rule 102 for column C 408 is:

[symbol]

EARLIERTHAN(x, “1995-09-19”) [symbol] [symbol] LATERTHAN(x, “1999-06-01”)

Subsequently at step 350 the profiler 100 checks if there are any more date fields to be processed in column C 408. Step 350 determines that field 432 is yet to be processed and returns to step 344. At step 344 the profiler 100 loops to the next date field in column C 408 which is field 432. At step 346 the profiler 100 determines if the value of date field 432 satisfies the profile rule 102 for column C 408. The profile rule 102 for column C at this point is “ [symbol] EARLIERTHAN(x,“1995-09-19”) [symbol] [symbol] LATERTHAN(x, “1999-06-01”)” and the value of field 432 is. “2001-03-31”. Thus step 346 determines that the value of the field 432 does not satisfy the profile rule 102 of column C 408 and proceeds to step 348. At step 348 the profile rule 102 for column C 408 is adapted to include the value of field 432 by changing the latest date of the profile 102 to the value of field 432. Thus at this point the profile rule 102 for column C 408 is “ [symbol] EARLIERTHAN(x, “1995-09-19”) [symbol] [symbol] LATERTHAN(x, “2001-03-31”)”.

Returning now to the method of FIG. 2 on completion of step 214, step 216 determines that there are no more columns of database 402 to be processed and the method of FIG. 2 is complete. Following the methods of FIGS. 2, 3a, 3b and 3c applied to the database table 402 of FIG. 4, a profile set 110 for each profile rule 102 corresponding to columns A 404, B 406 and C 408 can be defined. For column A 404 the profile rule 102 is defined as:

(x [symbol] 45) [symbol] (x [symbol] 72)

The corresponding profile set 110 for column A 404 is therefore:

{xεZ:(x [symbol] 45) [symbol] (x [symbol] 72)}

For column B 406 the profile rule 102 is defined as:

STARTSWITH(x,“GB”) [symbol] STARTSWITH(x,“DE”)

The corresponding profile set 110 for column B 406 is therefore:

{xεSTRING:STARTSWITH(x,“GB”) [symbol] STARTSWITH(x,“DE”)}

For column B 406 the profile rule 102 is defined as:

[symbol]

EARLIERTHAN(x,“1995-09-19”) [symbol] [symbol] LATERTHAN(x,“2001-03-31”)

The corresponding profile set 110 for column B 406 is therefore:

{xεDATE: [symbol] EARLIERTHAN(x,“1995-09-19”) [symbol] [symbol] LATERTHAN(x,“2001-03-31”)}

To demonstrate the operation of the selection checker, the profile set 110 for each of columns A 404, B 406 and C 408 will now be considered with respect to the selection rules in the table below. Each selection rule 108 is labelled from L to Q for ease of reference, and each selection rule 108 takes the form of a typical database query as is well known in the art. Each selection rule 108 is considered in turn and for each selection rule 108 a selection set is defined, and the operation of the selection checker 114 is considered.

| | Selection Rule 108 |
|---|---|
| Rule | Select from database table 402 where Column A 404 < |
| L | ‘20’ |
| Rule | Select from database table 402 where Column A 404 = |
| M | ‘52’ |
| Rule | Select from database table 402 where Column B 406 = |
| N | “FRQLSOW” |
| Rule | Select from database table 402 where Column B 406 = |
| O | “GBAPTOS” |
| Rule | Select from database table 402 where Column C 408 = |
| p | 1999-06-01 |
| Rule | Select from database table 402 where Column C 408 = |
| Q | 1975-03-03 |

Considering rule L from the table above, the database query is “Select from database table 402 where Column A<20” which corresponds to the selection rule 108:

x<20

Note that x is an identifier corresponding to “all data items” and is used here to represent all data items in column A in accordance with the database query for rule L. This selection rule 108 therefore defines the selection set:

{xεZ:x<20}

The database query including rule L relates to column A 404, so the selection checker 114 evaluates the intersection 116 of the profile set 110 for column A 404 and the selection set 112 for rule L as follows:

$$\begin{matrix} intersection 116 for rule L = profile set 110 for column A 404 ⋂ \\ selection set 112 for rule L = \{ x ∈ Z : ( x 45 ) ⋀ ( x 72 ) \} ⋂ \\ \{ x ∈ Z : x < 20 \} \\ = \{ \} ( the empty set )\end{matrix}$$

Thus there is an empty intersection 116 of the profile set 110 for column A 404 and the selected set 112 for rule L because the intersection 116 is the empty set. This indicates that the database table 402 does not contain any data items which would satisfy the database query in rule L. On inspection we can confirm that this is correct because the database table 402 does not contain any fields in column A 404 with a value less than ‘20’.

Now considering rule M from the table above, the database query is “Select from database table 402 where Column A=52” which corresponds to the selection rule 108:

x=52

This selection rule 108 therefore defines the selection set:

{xεZ:x=52}

The database query including rule M relates to column A 404, so the selection checker 114 evaluates the intersection 116 of the profile set 110 for column A 404 and the selection set 112 for rule M as follows:

$$\begin{matrix}intersection 116 for rule M = profile set 110 for colum A 404 ⋂ \\ selection set 112 for rule M = \{ x ∈ Z : ( x 45 ) ⋀ ( x 72 ) \} ⋂ \\ \{ x ∈ Z : x = 52 \} \\ = \{ x ∈ Z : x = 52 \}\end{matrix}$$

Thus there is non-empty intersection 116 of the profile set 110 for column A 404 and the selected set 112 for rule M because the intersection 116 is not the empty set. This indicates that the database table 402 may contain a data item which satisfies the database query in rule M. On inspection we can see that in fact the database table 402 does not contain any elements which satisfy the database query for rule M, although the non-empty intersection 116 for rule M means it is not possible to conclude that the database table 402 definitely does not include any data items which satisfy the selection rule 108 for rule M. This is because the profile rule 102 for column A 404 describes column A 404 as including numerical data items with values greater than or equal to ‘45’ and less than or equal to ‘72’, and the selection rule 108 for rule M falls within this profile rule 102.

Now considering rule N from the table above, the database query is “Select from database table 402 where Column B=“FRQLSOW”” which corresponds to the selection rule 108:

x=“FRQLSOW”

This selection rule 108 therefore defines the selection set:

{xεSTRING:x=“FRQLSOW”}

The database query including rule N relates to column B 406, so the selection checker 114 evaluates the intersection 116 of the profile set 110 for column B 406 and the selection set 112 for rule N as follows:

$$\begin{matrix}intersection 116 for rule N = profile set 110 for column B 406 ⋂ \\ selection set 112 for rule N = \{ x ∈ STRING : STARTSWITH ( x , ' ' GB '' ) ⩔ \\ STARTSWITH ( x , '' DE '' ) \} ⋂ \{ x ∈ STRING : x = ' ' FRQLSOW '' \} \\ = \{ \} ( the empty set )\end{matrix}$$

Thus there is an empty intersection 116 of the profile set 110 for column B 406 and the selected set 112 for rule N because the intersection 116 is the empty set. This indicates that the database table 402 does not contain any data items which would satisfy the database query in rule N. On inspection we can confirm that this is correct because the database table 402 does not contain any fields in column B 406 with a value of “FRQLSOW”.

Now considering rule O from the table above, the database query is “Select from database table 402 where Column B=“GBAPTOS”” which corresponds to the selection rule 108:

x=“GBAPTOS”

This selection rule 108 therefore defines the selection set:

{xεSTRING:x=“GBAPTOS”}

The database query including rule O relates to column B 406, so the selection checker 114 evaluates the intersection 116 of the profile set 110 for column B 406 and the selection set 112 for rule O as follows:

$$\begin{matrix}intersection 116 for rule O = profile set 110 for column B 406 ⋂ \\ selection set 112 for rule O = \{ x ∈ STRING : STARTSWITH ( x , ) '' GB '' ) ⩔ \\ STARTSWITH ( x , '' DE '' ) \} ⋂ \{ x ∈ STRING : x = '' GBAPTOS '' \} \\ = \{ x ∈ STRING : x = '' GBAPTOS '' \}\end{matrix}$$

Thus there is non-empty intersection 116 of the profile set 110 for column B 406 and the selected set 112 for rule O because the intersection 116 is not the empty set. This indicates that the database table 402 may contain a data item which satisfies the database query in rule O. On inspection we can see that in fact the database table 402 does contain an element which satisfies the database query for rule O because field 430 has the value “GBAPTOS”.

Now considering rule P from the table above, the database query is “Select from database table 402 where Column C=1999-06-01” which corresponds to the selection rule 108:

x=1999-06-01

This selection rule 108 therefore defines the selection set:

{xεDATE:x=1999-06-01}

The database query including rule P relates to column C 408, so the selection checker 114 evaluates the intersection 116 of the profile set 110 for column C 408 and the selection set 112 for rule P as follows:

$$\begin{matrix}intersection 116 for rule P = profile set 110 for column C 408 ⋂ \\ selection set 112 for rule P = \{ x ∈ DATE : ⫬ EARLIERTHAN ( x , '' 1995 - 09 - 19 '' ) ⩓ \\ ⫬ LATERTHAN ( x , ' ' 2001 - 03 - 31 '' ) \} ⋂ \\ \{ x ∈ DATE : x = 1999 - 06 - 01 \} \\ = \{ x ∈ DATE : x = 1999 - 06 - 01 \}\end{matrix}$$

Thus there is non-empty intersection 116 of the profile set 110 for column C 408 and the selected set 112 for rule P because the intersection 116 is not the empty set. This indicates that the database table 402 may contain a data item which satisfies the database query in rule P. On inspection we can see that in fact the database table 402 does contain an element which satisfies the database query for rule P because field 426 has the value 1999-06-01.

Now considering rule Q from the table above, the database query is “Select from database table 402 where Column C=1975-03-03” which corresponds to the selection rule 108:

x=1975-03-03

This selection rule 108 therefore defines the selection set:

{xεDATE:x=1975-03-03}

The database query including rule Q relates to column C 408, so the selection checker 114 evaluates the intersection 116 of the profile set 110 for column C 408 and the selection set 112 for rule Q as follows:

$$\begin{matrix}intersection 116 for rule Q = profile set 110 for column C 408 ⋂ \\ selection set 112 for rule Q = \{ x ∈ DATE : ⫬ EARLIERTHAN ( x , ' ' 1995 - 09 - 19 '' ) ⩓ \\ ⫬ LATERTHAN ( x , ' ' 2001 - 03 - 31 '' ) \} ⋂ \\ \{ x ε DATE : x = 1975 - 03 - 03 \} \\ = \{ \} ( the empty set )\end{matrix}$$

Thus there is an empty intersection 116 of the profile set 110 for column C 408 and the selected set 112 for rule Q because the intersection 116 is the empty set. This indicates that the database table 402 does not contain any data items which would satisfy the database query in rule Q. On inspection we can confirm that this is correct because the database table 402 does not contain any fields in column C 408 with a value of 1975-03-03.

While the preferred embodiments have been described here in detail, it will be clear to those skilled in the art that many variants are possible without departing from the spirit and scope of the present invention.

What is claimed:

1. A method for, in a data store comprising a first set of one or more data items, accessing a selected set comprising a second set of one or more data items in accordance with a selection rule, the method comprising the steps of:
creating a profile of the data store, the profile comprising a profile rule defining a profile set, wherein the profile set comprises a third set of one or more data items in accordance with the profile rule;
responsive to a determination that there is a non-empty intersection of the selected set and the profile set, extracting a fourth set of one or more data items from the data store in accordance with the selection rule; and
responsive to a determination that there is not a non-empty intersection of the selected set and the profile set, providing an indication that the data store does not include data items in the selected set.

2. The method of claim 1 wherein the first set of one or more data items includes numeric data.

3. The method of claim 1 wherein the first set of one or more data items includes string data.

4. The method of claim 1 wherein the first set of one or more data items includes date information.

5. The method of claim 1 wherein the first set of one or more data items includes graphical data.

6. The method of claim 1 wherein the first set of one or more data items includes sound data.

7. The method of claim 1 wherein the first set of one or more data items includes video data.

8. The method of claim 1 wherein the data store includes a relational database.

9. The method of claim 1 wherein the data store includes a hierarchical database.

10. The method of claim 1 wherein the data store includes an object oriented database.

11. The method of claim 1 wherein the data store includes an input/output software library.

12. The method of claim 1 wherein the data store includes a disk storage device.

13. The method of claim 1 wherein the data store includes a plurality of disk storage devices.

14. The method of claim 13 wherein the plurality of disk storage devices includes a redundant array of independent disks.

15. The method of claim 1 wherein the data store includes a random access memory.

16. The method of claim 1 wherein the creating a profile step take place when the data store is otherwise idle.

17. A computer program product directly loadable into the internal memory of a digital computer, comprising software code portions for performing, when said product is run on a computer, the method of, in a data store comprising a first set of one or more data items, accessing a selected set comprising a second set of one or more data items in accordance with a selection rule, the method comprising the steps of:
creating a profile of the data store, the profile comprising a profile rule defining a profile set, wherein the profile set comprises a third set of one or more data items in accordance with the profile rule;
responsive to a determination that there is a non-empty intersection of the selected set and the profile set, extracting a fourth set of one or more data items from the data store in accordance with the selection rule; and
responsive to a determination that there is not a non-empty intersection of the selected set and the profile set, providing an indication that the data store does not include data items in the selected set.

18. The computer program product claim 17 wherein the first set of one or more data items includes numeric data.

19. The computer program product claim 17 wherein the first set of one or more data items includes string data.

20. The computer program product claim 17 wherein the first set of one or more data items includes date information.

21. The computer program product claim 17 wherein the first set of one or more data items includes graphical data.

22. The computer program product claim 17 wherein the first set of one or more data items includes sound data.

23. The computer program product claim 17 wherein the first set of one or more data items includes video data.

24. The computer program product claim 17 wherein the data store includes a relational database.

25. The computer program product claim 17 wherein the data store includes a hierarchical database.

26. The computer program product claim 17 wherein the data store includes an object oriented database.

27. The computer program product claim 17 wherein the data store includes an input/output software library.

28. The computer program product claim 17 wherein the data store includes a disk storage device.

29. The computer program product claim 17 wherein the data store includes a plurality of disk storage devices.

30. The computer program product claim 29 wherein the plurality of disk storage devices includes a redundant array of independent disks.

31. The computer program product claim 17 wherein the data store includes a random access memory.

32. The computer program product claim 17 wherein the creating a profile step take place when the data store is otherwise idle.

33. A computer program product stored on a computer usable medium, comprising:
computer readable program means for storing data, the means for storing data being operable to store a first set of one or more data items;
computer readable program means for extracting a selected set from the data store, wherein the selected set comprises a second set of one or more data items in accordance with a selection rule;
computer readable program means for generating a profile of the first set of one or more data items, the profile comprising a profile rule defining a profile set, wherein the profile set comprises a third set of one or more data items in accordance with the profile rule; and
computer readable program means for determining if there is a non-empty intersection of the selected set and the profiler set.

34. The computer program product of claim 33 wherein the first set of one or more data items includes numeric data.

35. The computer program product of claim 33 wherein the first set of one or more data items includes string data.

36. The computer program product of claim 33 wherein the first set of one or more data items includes date information.

37. The computer program product of claim 33 wherein the first set of one or more data items includes graphical data.

38. The computer program product of claim 33 wherein the first set of one or more data items includes sound data.

39. The computer program product of claim 33 wherein the first set of one or more data items includes video data.

40. The computer program product of claim 33 wherein the computer readable program means for storing data includes a relational database.

41. The computer program product of claim 33 wherein the computer readable program means for storing data includes a hierarchical database.

42. The computer program product of claim 33 wherein the computer readable program means for storing data includes an object oriented database.

43. The computer program product of claim 33 wherein the computer readable program means for storing data includes an input/output software library.

44. The computer program product of claim 33 wherein the computer readable program means for storing data includes a disk storage device.

45. The computer program product of claim 33 wherein the computer readable program means for storing data includes a plurality of disk storage devices.

46. The computer program product of claim 45 wherein the plurality of disk storage devices includes a redundant array of independent disks.

47. The computer program product of claim 33 wherein the computer readable program means for storing data includes a random access memory.

48. The computer program product of claim 33 wherein the computer readable program means for generating a profile generates the profile when the computer readable program means for storing data is otherwise idle.

49. An apparatus having a data store operable to store a first set of one or more data items, the apparatus further comprising:
a selector for extracting a selected set from the data store, wherein the selected set comprises a second set of one or more data items in accordance with a selection rule;
a profiler for generating a profile of the data store, the profile comprising a profile rule defining a profile set, wherein the profile set comprises a third set of one or more data items in accordance with the profile rule; and
a selection checker for determining if there is a non-empty intersection of the selected set and the profiler set.

50. The apparatus of claim 49 wherein the first set of one or more data items includes numeric data.

51. The apparatus of claim 49 wherein the first set of one or more data items includes string data.

52. The apparatus of claim 49 wherein the first set of one or more data items includes date information.

53. The apparatus of claim 49 wherein the first set of one or more data items includes graphical data.

54. The apparatus of claim 49 wherein the first set of one or more data items includes sound data.

55. The apparatus of claim 49 wherein the first set of one or more data items includes video data.

56. The apparatus of claim 49 wherein the first set of one or more data items includes a relational database.

57. The apparatus of claim 49 wherein the data store includes a hierarchical database.

58. The apparatus of claim 49 wherein the data store includes an object oriented database.

59. The apparatus of claim 49 wherein the data store includes an input/output software library.

60. The apparatus of claim 49 wherein the data store includes a disk storage device.

61. The apparatus of claim 49 wherein the data store includes a plurality of disk storage devices.

62. The apparatus of claim 61 wherein the plurality of disk storage devices includes a redundant array of independent disks.

63. The apparatus of claim 49 wherein the data store includes a random access memory.

64. The apparatus of claim 49 wherein the profiler generates the profile when the data store is otherwise idle.
